(19) United States
(12) Patent Application Publication
(10) Pub. No.: US 2017/0039494 A1
(43) Pub. Date: Feb. 9, 2017

(54) INSPECTION INFORMATION MANAGEMENT METHOD AND INSPECTION INFORMATION MANAGEMENT SYSTEM

(71) Applicant: FUJITSU LIMITED, Kawasaki-shi (JP)

(72) Inventors: Masaki KURODA, Kita (JP); Yuta SHIOIRI, Kawasaki (JP); Yoko SAITO, Kawasaki (JP); Toshiyuki MARUYAMA, Kawasaki (JP); lwao KAKEGAWA, Kawasaki (JP)

(73) Assignee: FUJITSU LIMITED, Kawasaki-shi (JP)

(21) Appl. No.: 15/263,591

(22) Filed: Sep. 13, 2016

Related U.S. Application Data
(63) Continuation of application No. PCT/JP2014/059206, filed on Mar. 28, 2014.

(51) Int. Cl. G06Q 10/06

(52) U.S. Cl. CPC G06Q 10/0633; G06F 17/30241

(57) ABSTRACT

An inspection information management method includes receiving selection of a first pointer as a pointer subject to restoration after the first pointer has been selected as a pointer subject to deletion, the first pointer being a pointer indicating an inspection location on a map indicating an arrangement of facilities or a pointer indicating an inspection location included in an inspection route indicating an order of inspection locations subject to inspection, the first pointer being stored in association with accompanying information; and restoring the first pointer and the accompanying information such that the accompanying information is in an editable state when the map or the inspection route is not subject to deletion; or restoring the first pointer and the accompanying information such that the accompanying information is in an uneditable state when the map or the inspection route in association with the first pointer is subject to deletion.

### CROSS-REFERENCE TO RELATED APPLICATIONS

This application is a continuation application of International Application PCT/JP2014/059206 filed on Mar. 28, 2014 and designated the U.S., the entire contents of which are incorporated herein by reference.

### FIELD

The disclosure discussed herein relate to an inspection information management method and an inspection information management system.

### BACKGROUND

There are systems for assisting facility inspection work conducted in plants or the like known in the art. In such systems, various types of accompanying information including inspection results may be stored in storage devices such as databases in association with pointers indicating inspection parts in inspection routes illustrated in a map.

In general-purpose computers in the systems, when a user performs an operation to delete information stored in the storage devices, other information in association with the information subject to deletion is simultaneously deleted with the information subject to deletion. When the user performs an operation to restore the deleted information, the deleted other information in association with the information subject to restoration is simultaneously restored with such information subject to restoration.

### RELATED ART DOCUMENTS

### Patent Document

Patent Document 1: Japanese Laid-open Patent Publication No. 2006-92021

### SUMMARY

According to an aspect of embodiments, there is provided an inspection information management method executed by a computer. The inspection information management method includes receiving selection of a first pointer as a pointer subject to restoration after the first pointer has been selected as a pointer subject to deletion, the first pointer being one of a pointer indicating an inspection location displayed on a map indicating an arrangement of facilities and a pointer indicating an inspection location included in an inspection route indicating an order of a plurality of inspection locations subject to inspection, the first pointer being stored in association with accompanying information; and restoring the first pointer and the accompanying information such that the accompanying information is in an editable state in a case where one of the map and the inspection route in association with the first pointer is not subject to deletion; or restoring the first pointer and the accompanying information such that the accompanying information is in an uneditable state in a case where one of the map and the inspection route in association with the first pointer is subject to deletion.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating a system configuration example of an inspection information management system;

FIG. 2 is a diagram illustrating an example of a pin definition database;

FIG. 3 is a diagram illustrating an example of a pin record database;

FIG. 4 is a diagram illustrating an example of a route definition database;

FIG. 5 is a diagram illustrating an example of a route record database;

FIG. 6 is a diagram illustrating an example of a map definition database;

FIGS. 7A to 7C are diagrams illustrating layers of a map;

FIG. 8 is a diagram illustrating an example of an attachment database;

FIG. 9 is a diagram illustrating an example of a trash box database;

FIG. 10 is a diagram illustrating a hardware configuration example of a server;

FIG. 11 is a diagram illustrating functional configurations of a terminal apparatus and the server included in the inspection information management system;

FIG. 12 is a flowchart illustrating inspection work in the inspection information management system;

FIG. 13 is a flowchart illustrating a deletion process of a pin subject to deletion in the inspection information management system;

FIG. 14 is a flowchart illustrating a deletion process of a pin subject to restoration in the inspection information management system;

FIG. 15 is a flowchart illustrating a process of the server that has received a display request to display the restored pin from the terminal apparatus;

FIG. 16 is a diagram illustrating an example of a list screen of a trash box displayed on the terminal apparatus;

FIGS. 17A and 17B are diagrams illustrating the map before the pin ID “P0002” is restored and the map after the pin ID “P0002” is restored;

FIGS. 18A and 18B are examples of screens via which a pin subject to display is searched for;

FIG. 19 is a diagram illustrating an example of a screen displaying the pin record information;

FIG. 20 is a flowchart illustrating a deletion process of an attachment file in the inspection information management system;

FIG. 21 is a flowchart illustrating a restoration process of an attachment file in the inspection information management system;

FIG. 22 is a flowchart illustrating a process of the server that has received a display request to display the restored attachment file from the terminal apparatus;

FIG. 23 is a diagram illustrating an example of a state where an attachment ID “T01” is restored; and

FIG. 24 is a diagram illustrating an example of a search result of the attachment ID “T01”.

### DESCRIPTION OF EMBODIMENTS

In the above-described related art systems, there may be a case where the inspection routes or the map including a certain pointer may be changed or deleted after the certain pointer and information accompanying this pointer are deleted.

In this case, when the user attempts to restore the deleted pointer and the accompanying information associated with the pointer, there are no inspection routes or map. As a result, the pointer that the user selects to restore at this point has no corresponding inspection parts.

In the above-described system, if the pointer having no corresponding inspection parts is deleted together with the accompanying information, a user may erroneously edit the accompanying information associated with the pointer having no corresponding inspection parts. That is, the accompanying information that originally should not be editable may be edited in the above-described system.

According to an aspect of embodiments, it is desirable to provide an inspection information management method and an inspection information management system capable of controlling permission and prevention of editing the restored information.

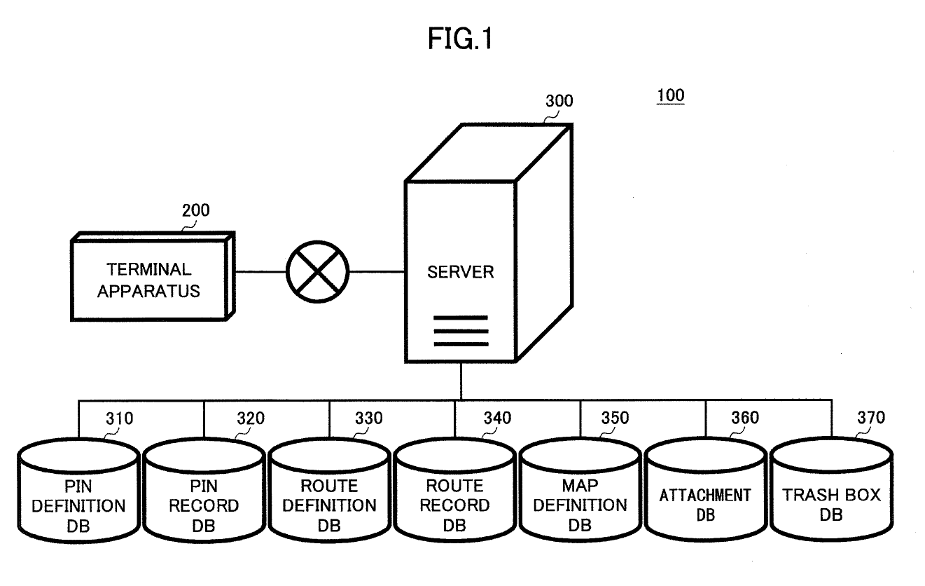

The following illustrates embodiments of the present invention with reference to the accompanying drawings. FIG. 1 is a diagram illustrating an example of a system configuration of an inspection information management system 100 according to an embodiment.

The inspection information management system 100 according to the embodiment includes a terminal apparatus 200 and a server 300 that are connected via a network.

The inspection information management system 100 is configured to assist inspection work of various types of facilities conducted by inspection workers within plants such as factories and electric generation plants.

The server 300 of the embodiment includes a pin definition database (DB) 310, a pin record database (DB) 320, a route definition database (DB) 330, a route record database (DB) 340, a map definition database (DB) 350, an attachment database (DB) 360, and a trash box database (DB) 370.

The terminal apparatus 200 of the embodiment is configured to assist inspection work upon activation of an inspection assisting program executed by an inspection worker. More specifically, the terminal apparatus 200 refers to the pin definition DB 310, the route definition DB 330, and the map definition DB 350, and displays pointers (hereinafter referred to as “pins”) indicating inspection parts based on an inspection route illustrated in a map. The terminal apparatus 200 also refers to the pin definition DB 310, and displays an input screen having an entry field with items related to the pin to prompt the inspection worker to input inspection result values corresponding to the items in the entry field. The terminal apparatus 200 assists the inspection work in the above-described manner. The terminal apparatus 200 of the embodiment thus serves as an inspection assisting apparatus.

When the terminal apparatus 200 receives inspection result values input for all the pins included in the inspection route, the terminal apparatus 200 transmits the inspection results to the server 300 to store the inspection results in the pin record DB 320 and the route record DB 340. Note the in the following embodiments, an inspection result may represent a collection of the inspection result values input via the input screen corresponding to the pins.

When the terminal apparatus 200 receives files such as images or documents associated with the pins, the terminal apparatus 200 stores these files in the attachment DB 360 as attachment information associated with the pins. In the following embodiments, attachment information associated with the pins may be called “pin attachment files”.

In the embodiments, the inspection result associated with the pins, the attachment files, and the pin information including pin types or maps to which the pins belong may be called accompanying information associated with the pins. The accompanying information may further include other information associated with the pins.

When the user (i.e., the inspection worker) performs an operation to delete a certain pin on the map of the terminal apparatus 200, the server 300 moves the deleted pin and the inspection result associated with the deleted pin to the pin definition DB 310. When the user performs an operation to delete the pin attachment file, the server 300 moves the pin attachment file from the attachment DB 360 to the trash box DB 370. When the user performs an operation to restore the deleted pin or the attachment file in the terminal apparatus 200, the server 300 removes the inspection result associated with the pin or the attachment file from the trash box DB 370 to return the removed inspection result associated with the pin or the attachment file to the pin definition DB 310 or the attachment DB 360.

In restoration of the above-described pin or attachment file, the server 300 controls permission for or prevention editing of the inspection result or the attachment file, based on a correspondence relationship between the pins and the map, a correspondence relationship between the pins and the inspection route, and a correspondence relationship between the pins and the attachment file. More specifically, the server 300 prevents the editing the inspection results of the pins or attachment files that do not exist on the map or in the inspection route, and permits the editing the inspection results or the attachment files that exist on the map or in the inspection route. The server 300 of the embodiment thus serves as an inspection information management apparatus.

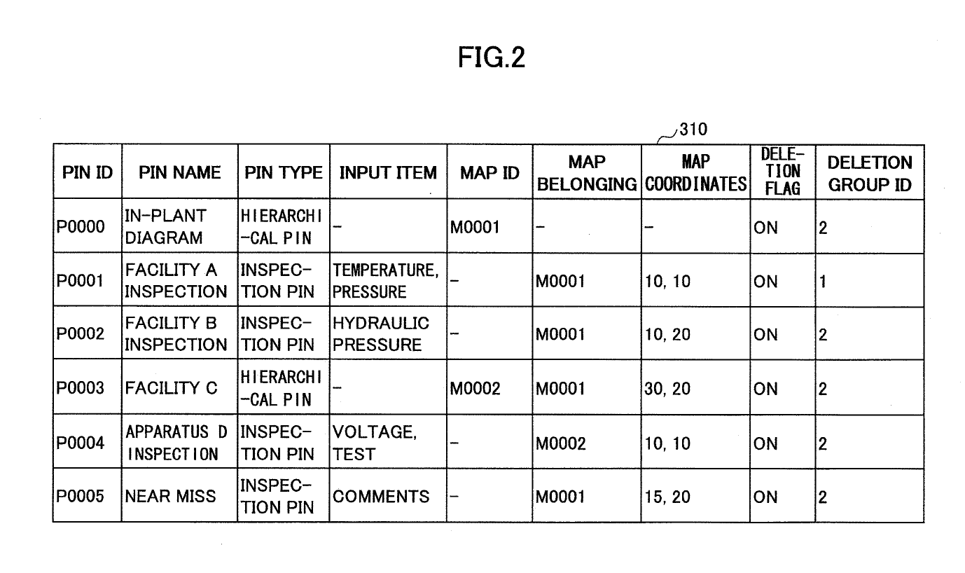

The following illustrates respective databases included in the server 300 according to the embodiment with reference to FIGS. 2 to 9.

FIG. 2 is a diagram illustrating an example of the pin definition database (DB) 310.

The pin definition DB 310 according to an embodiment includes a pin ID as a key in association with a pin name, a pin type, an input item, a map ID, a map belonging, map coordinates, a deletion flag and a deletion group ID. In the following illustration, information items in association with the pin ID as a key in the pin definition DB 310 may be called “pin information”.

The pin ID is an identifier for identifying a pin. The pin name is a name of the pin. The pin type indicates a type of the pin. In this embodiment, there are two types of pins including a hierarchical pin and an inspection pin. The hierarchical pin illustrates a layer in the later-described map. The inspection pin illustrates an inspection part in the later-described map.

In the following description, layer types of pins are simply called “hierarchical pins” and inspection types of pins are simply called “inspection pins”.

The input items in an entry field correspond to items to be input as the inspection results obtained in the inspection work. In this embodiment, the input items are associated with the inspection pins such that the input items are determined corresponding to the pins.

The map IDs are associated with the hierarchical pins, and each map ID indicates a map of a layer indicated by a corresponding one of the hierarchical pins. The map belongings are associated with the inspection pins and the hierarchical pins, and the map belonging indicates a map including the inspection pins and the hierarchical pins. The map coordinates are associated with the inspection pins, and the map coordinates indicate a position of the inspection pin in the map including the inspection pin.

The deletion flag indicates whether a deletion process is performed on the corresponding pin ID. In this embodiment, the deletion flag being turned ON indicates that the pin indicated by the corresponding pin ID is deleted from the map. In the following embodiment, the deletion flag being turned ON may be expressed by “setting the deletion flag”. The deletion group ID is provided when the deletion flag is turned ON, and the same deletion group ID is given to the pin, the attachment file, and the route that are deleted simultaneously.

In the example of FIG. 2, a pin having the pin ID “P0000” is the hierarchical pin having the pin name “in-plant diagram”. The hierarchical pin having the pin ID “P0000” is associated with the map ID “M0001”. In FIG. 2, a pin having the pin ID “P0001” is the inspection pin having the pin name “facility A inspection”. The inspection pin ID having the pin ID “P0001” has input items “temperature” and “pressure”, and is positioned at coordinates (10, 10) in the map having the map ID “M0001”.

In FIG. 2, a pin having the pin ID “P0003” is the hierarchical pin having the pin name “facility C”. The hierarchical pin having the pin ID “P0003” belongs to the map having the map ID “M0001”, is positioned at coordinates (30, 20), and associated with the map ID “M0002”. That is, the hierarchical pin “P0003” defines a layer connected from the map ID “M0001” to the map ID “M0002”.

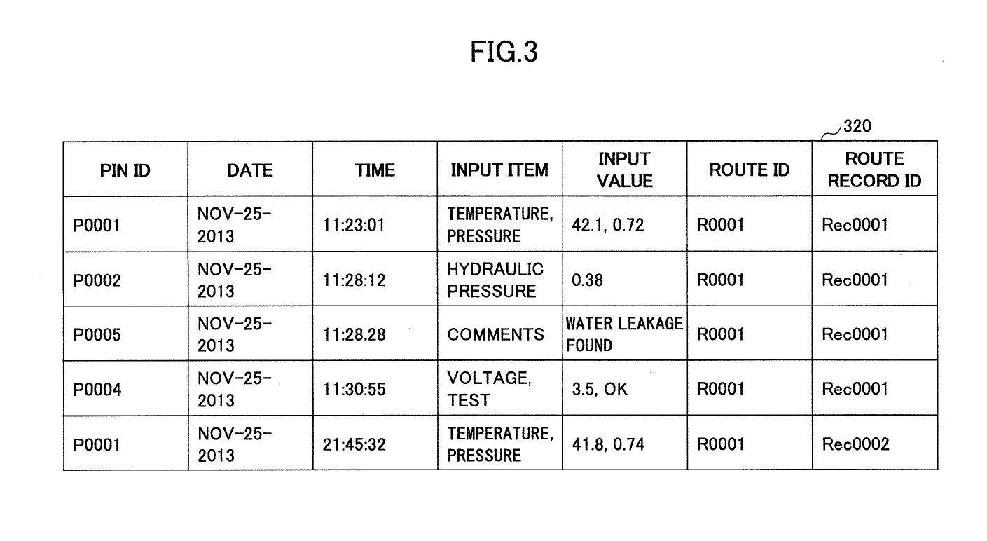

FIG. 3 is a diagram illustrating an example of the pin record database (DB) 320.

The pin record DB 320 according to an embodiment is configured to store an inspection result for each of the inspection pins.

The pin record DB 320 includes the pin ID as a key in association with a date, a time, an input item, an input value, a route ID, and a route record ID as other information items. In the following illustration, information items in association with the pin ID as a key in the pin record DB 320 may be called “pin record information”.

In the pin record DB 320, the date and the time indicate date and time at which an input value is input into the input item. The input items are associated with the inspection pins, and the input values are input in association with the input items.

The route ID is an identifier for identifying the inspection route including the inspection pins. The route record ID is an identifier for identifying an inspection result of each of the inspection routes.

In the example of FIG. 3, as the inspection result corresponding to the inspection pin having the pin ID “0002”, the input value “0.38” is input in the entry field corresponding to the input item “hydraulic pressure” in association with the date “Nov-25-2013” and the time “11:23:01”. The inspection pin having the pin ID “P0002” is included in the inspection route identified by the route ID “R0001”, and the inspection result of the inspection pin having the pin ID “P0002” is included in the route record identified by the route record ID “Rec0001”.

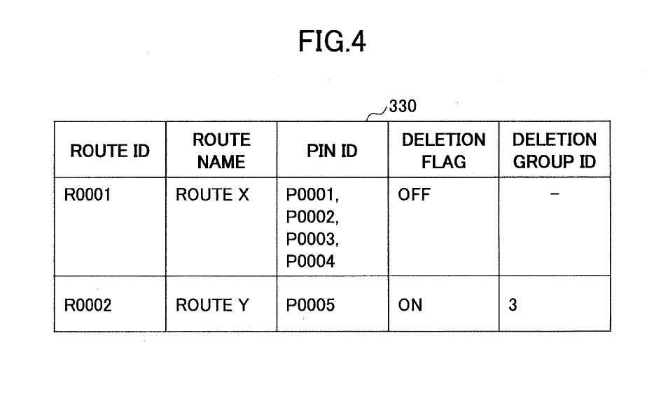

FIG. 4 is a diagram illustrating an example of the route definition database (DB) 330.

The route definition DB 330 according to an embodiment includes a route ID as a key in association with a route name, a pin ID, a deletion flag, and a deletion group ID as other items. In the following illustration, information items in association with the route ID as a key in the route definition DB 330 may be called “route information”.

In the route definition DB 330, the route ID is in association with the pin ID, indicating that a pin indicated by the pin ID is included in the inspection route indicated by the route ID. The deletion flag indicates whether a deletion process is performed on the corresponding route ID. In this embodiment, the deletion flag being turned ON indicates that the route indicated by the corresponding route ID is deleted from the map. The deletion group ID is provided when the deletion flag is turned ON, and the same deletion group ID is given to the pin, the attachment file, and the route that are deleted simultaneously.

In the example of FIG. 4, the inspection route having the route ID “R0001” and the route name “route X” includes inspection pins having the pin IDs “P0001”, “P0002” and “P0004”, and the hierarchical pin having the pin ID “P0003”. The route having the route ID “R0002” is deleted from the route definition DB 330.

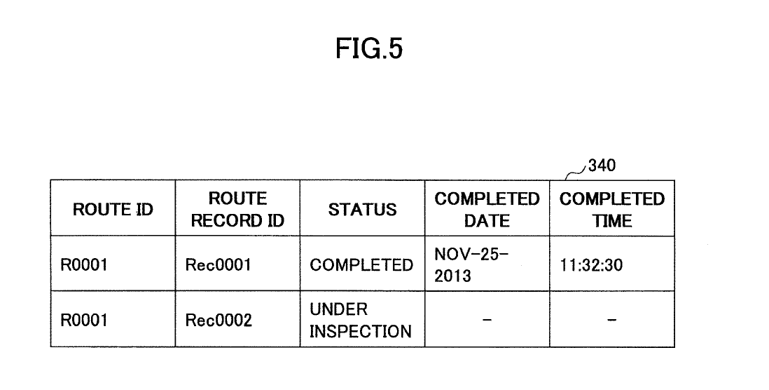

FIG. 5 is a diagram illustrating an example of the route record database (DB) 340.

The route record DB 340 according to an embodiment includes the route ID as a key in association with a route record ID, a status, a completed date, and a completed time as the other information items. In the following illustration, information items in association with the route ID as a key in the route record DB 340 may be called “route record information”.

The status in the route record DB 340 indicates an inspection work status of the inspection route indicated by the route ID. The completed date and completed time indicate date and time at which the inspection work of the inspection route indicated by the route ID has completed.

In the example of FIG. 5, the inspection result of the inspection route having the route ID “R0001” is recorded as a route record ID “Rec0001”, and indicates that the inspection work has completed at 11:32:30 on Nov. 25, 2013.

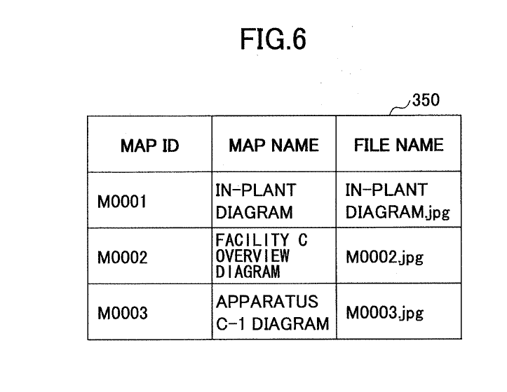

FIG. 6 is a diagram illustrating an example of the map definition database (DB) 350.

The map definition DB 350 according to an embodiment includes the map ID as a key in association with a map name, and a file name as another information item. In the following illustration, information items in association with the map ID as a key in the map definition DB 350 may be called “map information”.

The map name is a name of a map, and the file name is a name of a file used for displaying the map on the terminal apparatus 200.

Note that in the example of FIG. 5, the map definition DB 350 does not include the deletion flag and the deletion ID. The map IDs are associated with the hierarchical pins and the pin IDs. Thus, the deletion flag being turned ON corresponding to the hierarchical pin managed by the pin definition DB 310 indicates that the map having the map ID in association with the hierarchical pin has been deleted.

In the example of FIG. 6, the map name identified by the map ID “M0001” is “in-plant diagram”, and a file used for displaying the map is “in-plant diagram.jpg”.

In the map definition DB 350 of the embodiment may include a file illustrating an overall area subject to inspection such as a factory, a file indicating facility subject to inspection work, and a file indicating an apparatus within the facility subject to inspection, as different layers of the map.

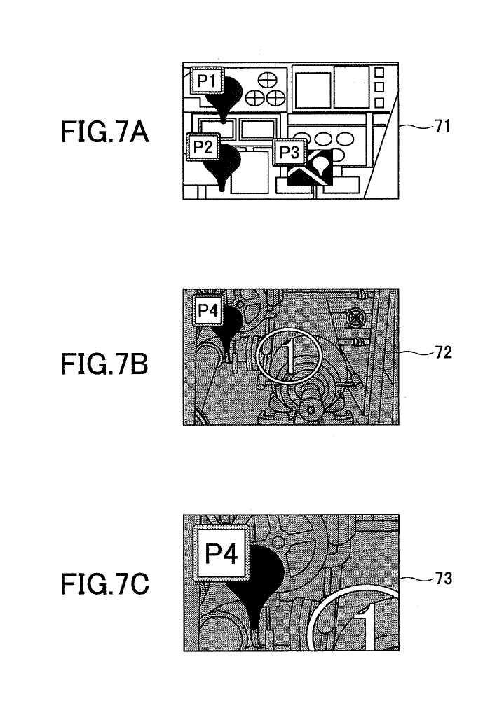

In the following, a description is given of layers of the map with reference to FIGS. 7A to 7C. FIGS. 7A to 7C are diagrams illustrating the layers of the map. More specifically, FIG. 7A illustrates an example of a first layer of the map, FIG. 7B illustrates an example of a second layer of the map, and FIG. 7C illustrates an example of the map enlarging a part subject to inspection of the second layer of the map.

FIG. 7A indicates a map 71 illustrating an area in which the facilities are disposed. The map 71 may be the in-plant diagram of the map having the map ID “M0001” registered in the map definition DB 350. The map 71 illustrates a hierarchical pin P3, an inspection pin P1, and an inspection pin P2. In this embodiment, it may be preferable to display the hierarchical pin and the inspection pins on the map with corresponding icon images based on the types of the pins.

FIG. 7B indicates a map 72 illustrating a lower layer of the map 71 including an outline of the facility in an area indicated by the hierarchical pin P3 of the map 71. That is, the map 72 illustrates particulars of the area indicated by the hierarchical pin P3 in the map 71. The map 72 may be the in-plant diagram of the map having the map ID “M0001” registered in the map definition DB 350. The map 72 displays an inspection pin P4. The inspection pin P4 indicates an apparatus subject to inspection within the facility displayed as the map 72.

FIG. 7C illustrates a map 73 displaying a part enlarging the inspection part of the map 72. FIG. 7C illustrates a layout of the apparatus subject to inspection indicated by the inspection P4.

That is, the lower the layer, the more detailed is the image of the inspection part displayed on the terminal apparatus 200 in this embodiment. In this embodiment, a relationship between the layers of the map stored in the map definition DB 350 may be indicated by the pins in association with the map and the inspection route including the pins.

The map definition DB 350 of the embodiment may include file names of the maps (e.g., image data) for displaying the map 71, the map 72, and the map 73 stored in association with the map IDs and the map names. In this embodiment, entities of the files for displaying the respective maps may be stored in the map definition DB 350, or the entities of the files may be stored in a different storage device.

The map definition DB 350 may include the map IDs in association with information indicating relationships between the layers of the maps. More specifically, the map immediately beneath (i.e., one layer beneath) the map having the map ID “M0001” corresponds to a map having the map ID “M0002”. Thus, the map ID “M0002” may be associated with information indicated by, for example, a map ID “M0001-1” indicating a map that is one layer beneath the map having the map ID “M0001”.

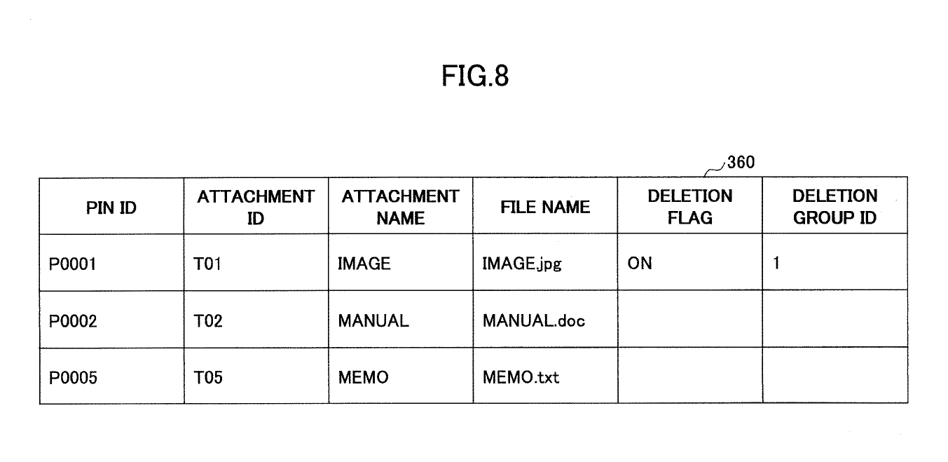

FIG. 8 is a diagram illustrating an example of the attachment DB 360. The attachment DB 360 according to an embodiment includes a pin ID as a key in association with an attachment ID, an attachment name, a file name, a deletion flag, and a deletion group ID as other items. In the following illustration, information items in association with the map ID as a key in the attachment DB 360 may be called “attachment information”.

The attachment ID is information identifying an attachment file attached to the pin corresponding to the pin ID. The attachment name is a name of an attachment file, and the file name is a name of a file used for displaying the attachment file on the terminal apparatus 200.

The deletion flag indicates whether the corresponding attachment ID has been deleted. In this embodiment, the deletion flag being turned ON indicates that the attachment file indicated by the corresponding attachment ID has been deleted from the attachment DB 360. The deletion group ID is provided when the deletion flag is turned ON, and the same deletion group ID is given to the attachment file and the pin that are deleted simultaneously.

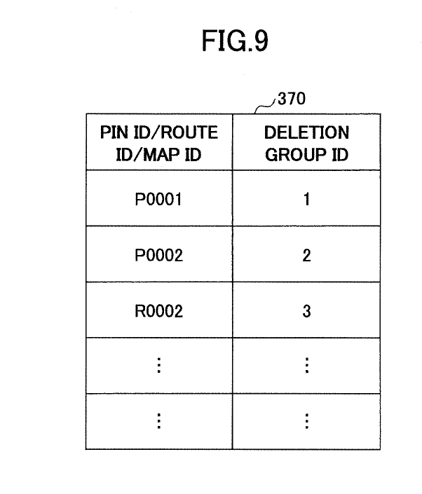

FIG. 9 is a diagram illustrating an example of the trash box database (DB) 370. The trash box DB 370 according to an embodiment includes information for specifying the pins the routes, the maps, and the attachment files subject to deletion selected in the terminal apparatus 200.

More specifically, the trash box DB 370 includes the deletion group ID stored in association with the pin ID, the route ID, the map ID, and the attachment ID. In this embodiment, when a display request to display a list of the deleted pins or the attachment files is transmitted by the terminal apparatus 200, the server 300 may acquire the pin IDs or the attachment IDs associated with the deletion group ID stored in the trash box DB 370, and transmits the acquired pin IDs or the attachment IDs to the terminal apparatus 200.

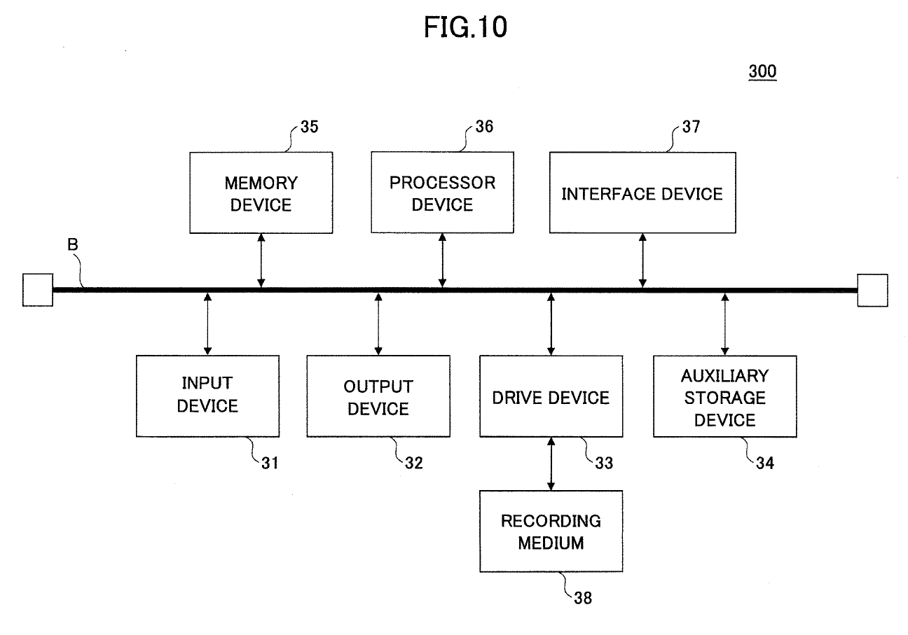

FIG. 10 is a diagram illustrating a hardware configuration example of a server 300 according to an embodiment. The server 300 includes an input device 31, an output device 32, a drive device 33, an auxiliary storage device 34, a memory device 35, a processor 36, and an interface device 37, which are connected to one another via a bus B.

The input device 31 includes a keyboard and a mouse, and is configured to input various types of signals. The output device 32 includes a display device, and is configured to display various types of windows or data. The interface device 37 may include a modem and a LAN card, and is configured to connect the server 300 to the network N.

An inspection information management program 380 described later may at least be a part of various types of programs controlling the server 300. The inspection information management program 380 may be provided by being distributed in a form of a recording medium 38 or downloaded from the network. Note that various types of recording media may be used as the recording medium 38 storing the inspection information management program 380, examples of which include a compact disk read-only memory (CR-ROM), a flexible disk, and a magneto-optical disk, or semiconductor memory or the like electrically recording information such as a read-only memory (ROM), a flash memory or the like.

When the recording medium 38 storing the inspection information management program 380 is set in the drive device 33, the inspection information management program 380 is installed from the recording medium 38 into the auxiliary storage device 34 via the drive device 33. When the inspection information management program 380 is downloaded via the network, the downloaded inspection information management program 380 is installed into the auxiliary storage device 34 via the interface device 27.

The auxiliary storage device 34 is configured to store the inspection information management program 380 as well as storing necessary files, data, and the like. The memory device 35 is configured to read the inspection information management program 380 from the auxiliary storage device 34 and store the read inspection information management program 380 at the startup of a computer. The processor 36 is configured to execute later-described various types of processes in accordance with the inspection information management program 380 stored in the memory device 35.

The terminal apparatus 200 according to an embodiment is a computer having a hardware configuration similar to that of the server 300, and a duplicated illustration of the hardware configuration is thus omitted from the specification. The terminal apparatus 200 of the embodiment may be a tablet computer. The terminal apparatus 200 of the embodiment may be a multifunctional mobile phone including a smartphone.

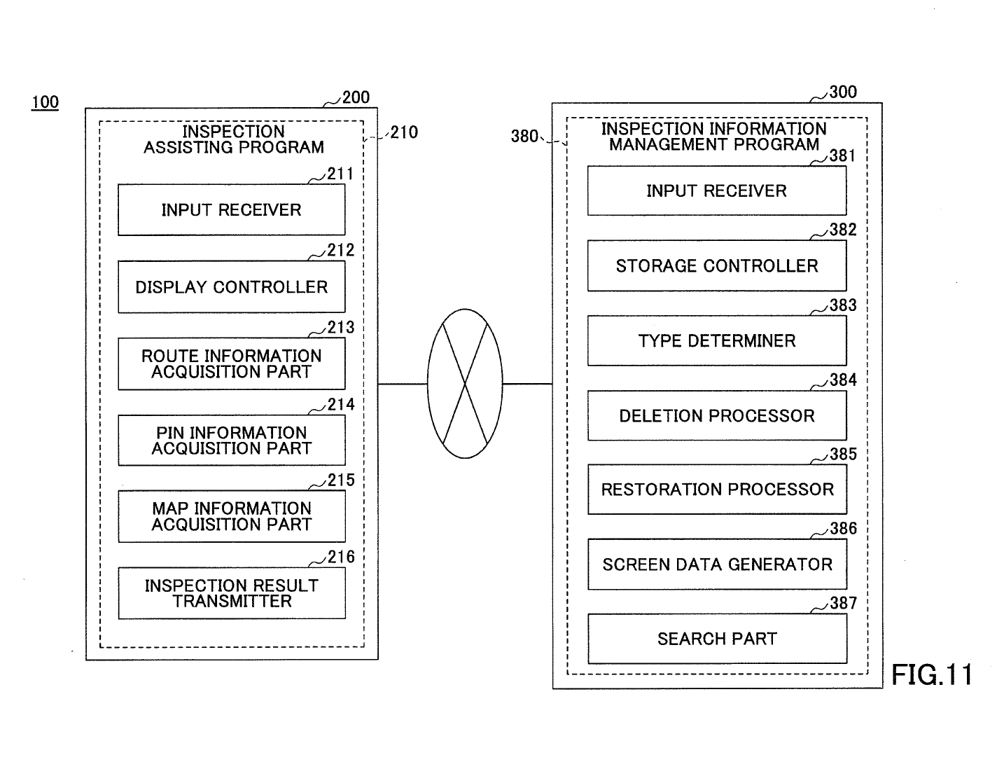

The following illustrates, with reference to FIG. 11, functional configurations of the terminal apparatus 200 and the server 300 included in the inspection information management system 100 according to an embodiment. FIG. 11 is a diagram illustrating functional configurations of the terminal apparatus 200 and the server 300 included in the inspection information management system 100.

The terminal apparatus 200 according to the embodiment has an inspection assisting program 210 installed therein. The terminal apparatus 200 of the embodiment executes the inspection assisting program 210 to implement later-described processes of the terminal apparatus components.

The terminal apparatus 200 according to the embodiment includes an input receiver 211, a display controller 212, a route information acquisition part 213, a pin information acquisition part 214, a map information acquisition part 215, and an inspection result transmitter 216.

The input receiver 211 is configured to receive inputs by operations of a display operations apparatus 21 included in the terminal apparatus 200. The display controller 212 is configured to control display of the display operations apparatus 21.

The route information acquisition part 213 is configured to acquire route information from the route definition DB 330, based on an input received by the input receiver 211. The pin information acquisition part 214 is configured to acquire pin information from the pin definition DB 310, based on an input received by the input receiver 211. The map information acquisition part 215 is configured to acquire map information from the map definition DB 350, based on a map ID included in the pin information.

The inspection result transmitter 216 is configured to transmit an inspection result to the server 300 when the inspection work of the selected inspection route has completed.

The server 300 according to the embodiment has an inspection information management program 380 installed therein. The server 300 of the embodiment executes the inspection information management program 380 to implement later-described processes of the server components.

The server 300 according to the embodiment includes an input receiver 381, a storage controller 382, a type determiner 383, a deletion processor 384, a restoration processor 385, an screen data generator 386, and a search part 387.

The input receiver 381 is configured to receive various types of inputs with respect to the server 300. The inputs received by the input receiver 381 includes various types of requests transmitted from the terminal apparatus 200. The storage controller 382 is configured to store the inspection results or attachment files transmitted from the terminal apparatus 200 into the associated databases.

The type determiner 383 is configured to determine whether the pin subject to deletion selected or the selected pin subject to restoration selected is a hierarchical pin or an inspection pin. The deletion processor 384 is configured to perform a deletion process of the selected pin subject to deletion. The restoration processor 385 configured to perform a restoration process of the selected pin subject to restoration. The screen data generator 386 is configured to generate, upon reception of a display request from the terminal apparatus 200, screen data to display, for example, restored information on the terminal apparatus 200. The search part 387 is configured to search the pin definition DB 310 by the pin ID of the selected pin subject to display by the terminal apparatus 200. An illustration of detailed processes of the deletion processor 384, the restoration processor 385, the screen data generator 386, and the search part 387 will be given later.

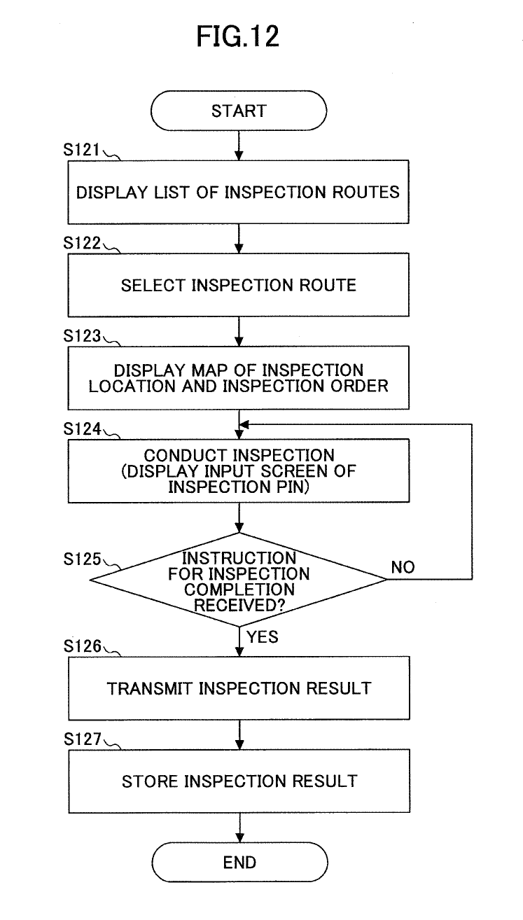

The following describes, with reference to FIG. 12, an overview of inspection work utilizing the inspection information management system 100 according to the embodiment. FIG. 12 is a flowchart illustrating the inspection work in the inspection information management system 100. FIG. 12 illustrates an overview of operations from a start to an end of the inspection work.

In the inspection information management system 100 according to the embodiment, when the inspection work has started, the terminal apparatus 200 causes the route information acquisition part 213 to acquire a list of inspection routes from the route definition DB 330, and causes the display controller 212 to display the acquired list of the inspection routes on the display operations apparatus 21 (step S121). The terminal apparatus 200 subsequently causes the input receiver 211 to receive the selection of the inspection route (step S122).

The terminal apparatus 200 displays a map of an inspection location (a location subject to inspection) and an inspection order, based on the selected inspection route (step S123), and assists the inspection work conducted by the inspection worker (step S124).

The terminal apparatus 200 subsequently determines whether completed indication of the inspection work has been received (step S125), and when the completed indication has not been received, returns to step S124. When the completed indication has been received in step S125, the terminal apparatus 200 transmits the inspection result to the server 300 (step S126).

When the input receiver 381 receives the inspection result, the server 300 causes the storage controller 382 to update the route record DB 340, and store the inspection result in the pin record DB 320 (step S127).

Note that according to the embodiment, the attachment files such as images capturing the inspection parts or memos created by the inspection worker may be associated with the inspection result. In such a case, the terminal apparatus 200 transmits the inspection results and attachment file to the server 300. The server 300 causes the storage controller 382 to provide the attachment ID to the transmitted attachment file and store the attachment ID in association with the pin ID of the corresponding pin in the attachment DB 360.

### First Embodiment

The following illustrates a first embodiment of the inspection information management system 100. In the first embodiment, a pin is deleted and restored in the terminal apparatus 200.

Initially, an illustration is given of a deletion process in the server 300 when the pin subject to deletion is selected in the terminal apparatus 200.

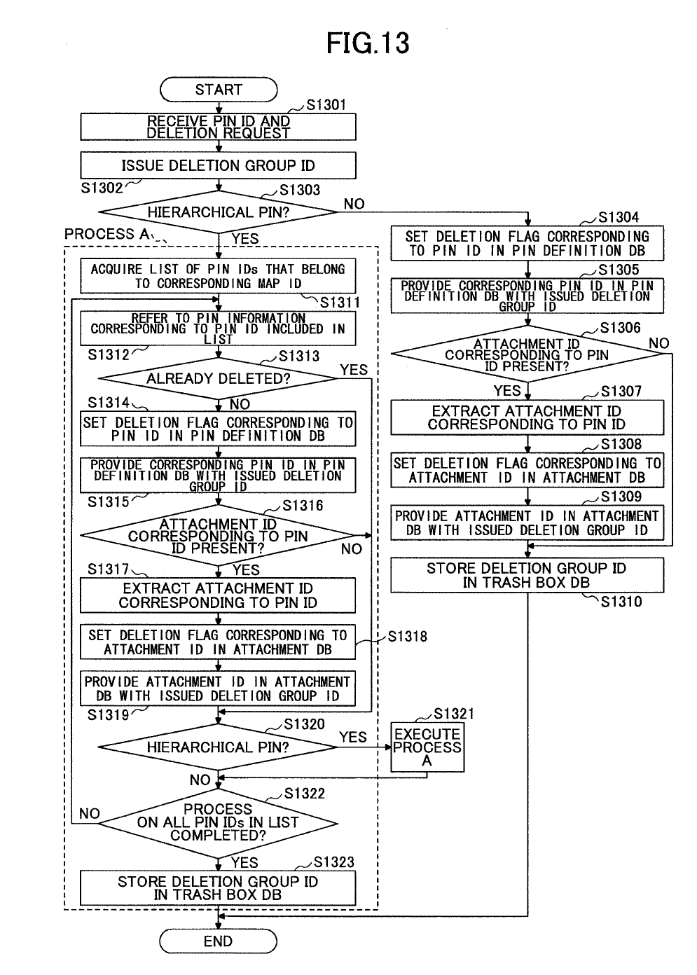

FIG. 13 is a flowchart illustrating a deletion process of the pin subject to deletion in the inspection information management system 100.

In this embodiment, the server 300 causes the input receiver 381 to receive the pin ID of the pin subject to deletion selected in the terminal apparatus 200 and the deletion request (step S1301). The server 300 subsequently causes the deletion processor 384 to issue the deletion group ID (step S1302).

The server 300 subsequently causes the type determiner 383 to refer to the pin definition DB 310 to determine whether the type of the pin of the received pin ID corresponds to a hierarchical pin (step S1303).

When the received pin is not the hierarchical pin in step S1303, the deletion processor 384 sets a deletion flag corresponding to the pin ID that does not correspond to the hierarchical pin in the pin definition DB 310 (step S1304). The deletion processor 384 subsequently provides the issued deletion group ID to the pin ID that does not correspond to the hierarchical pin in the pin definition DB 310 (step S1305).

The deletion processor 384 subsequently refers to the attachment DB 360 to determine whether there is an attachment ID corresponding to the pin ID subject to deletion (step S1306). When there is no attachment ID corresponding to the pin ID subject to deletion in step S1306, a later-described step S1310 is processed.

When there is an attachment ID corresponding to the pin ID subject to deletion in step S1306, the deletion processor 384 extracts the attachment ID corresponding to the pin ID subject to deletion in the attachment DB 360 (step S1307). The deletion processor 384 subsequently sets the deletion flag corresponding to the extracted attachment ID in the attachment DB 360 (step S1308), and provides the extracted attachment ID with the issued deletion group ID (step S1309). That is, in this embodiment, the deletion group ID provided with the selected pin ID subject to deletion and the deletion group ID provided with the attachment ID corresponding to the pin ID are identical.

The deletion processor 384 subsequently stores the issued deletion group ID into the trash box DB 370 (step S1310) to end the pin deletion process.

Next, an illustration is given of a case where the selected pin subject to deletion is a hierarchical pin in step S1303. The process from step S1311 to step S1323 illustrated below is called a process A in this embodiment.

When the pin subject to deletion is a hierarchical pin, the deletion processor 384 acquires a list of the pin IDs that belong to the map ID corresponding to the hierarchical pin in the pin definition DB 310 (step S1311). The deletion processor 384 acquires one of the pin IDs in the acquired list and refers to pin information of the picked pin ID (step S1312).

The deletion processor 384 subsequently determines whether the deletion flag is set corresponding to the acquired pin ID (step S1313). When the deletion flag is set corresponding to the acquired pin ID in step S1313, the deletion processor 384 moves to later-described step S1320.

When the deletion flag is not set corresponding to the acquired pin ID in step S1313, the deletion processor 384 moves to step S1314. The process from step S1314 to step S1319 is similar to the process from step S1304 to step S1309, and a duplicated description is thus omitted from the specification.

The deletion processor 384 subsequently determines whether the pin corresponding to the pin ID acquired in step S1312 is a hierarchical pin, based on information about the acquired pin ID (step S1320).

When the pin corresponding to the acquired pin ID is a hierarchical pin in step S1320, a process A is executed (step S1321).

When the pin corresponding to the acquired pin ID is not a hierarchical pin in step S1320, the deletion processor 384 determines whether the process from step S1312 to step S1322 has been performed on all the pin IDs included in the list acquired in step S1311 (step S1322). When the process from step S1312 to step S1322 has not been performed on all the pin IDs in step S1322, the deletion processor 384 returns to step S1312. When the process from step S1312 to step S1322 has been performed on all the pin IDs in step S1322, the deletion processor 384 stores the issued deletion group ID in the trash box DB 370 (step S1323) to end the process.

The following specifically illustrates a process of the deletion processor 384 according to an embodiment with reference to FIGS. 2 to 8.

Initially, a description is given a case where the pin ID “P0001” is selected as a pin ID subject to deletion.

When the server 300 receives the pin ID “P0001” and a deletion request, the server 300 causes the deletion processor 384 to refer to the pin definition DB 310 (see FIG. 2) to determine a pin type of the pin ID “P0001”. The pin ID “P0001” is an inspection pin. The deletion processor 384 thus sets the deletion flag corresponding to the pin ID “P0001”, and provides the pin ID “P0001” with the issued deletion group ID. In this example, the value of the deletion group ID set is “1”.

The deletion processor 384 subsequently refers to the attachment DB 360 to determine whether there is an attachment ID corresponding to the pin ID “P0001”. In FIG. 8, the attachment ID “T01” corresponds to the pin ID “P0001”. In this case, the deletion processor 384 sets the deletion flag corresponding to the attachment ID “T01”, and provide the deletion group ID with “1”. The deletion processor 384 subsequently stores the deletion group ID “1” in the trash box DB 370.

The deletion process of the pin ID “P0001” in this embodiment is thus completed as illustrated above.

Next, a description is given a case where the pin ID “P0000” is selected as a pin ID subject to deletion. The pin type of the pin ID “P0000” is a hierarchical pin. Note that a value of the deletion group ID issued in this process is determined as “2”.

The deletion processor 384 thus acquires a list of the pin IDs having the map ID “M0001” corresponding to the pin ID “P0000” as a value belonging to the map. In the example of FIG. 2, the deletion processor 384 acquires the pin IDs “P0001”, “P0002”, “P0003”, and “P0005”.

The deletion processor 384 subsequently performs the above-described process when the pin ID “P0001” is selected as a pin ID subject to deletion first. Since the pin ID “P0001” is not a hierarchical pin, the deletion processor 384 subsequently performs a similar process on the pin ID “P0002”. Since the pin ID “P0002” is not a hierarchical pin, the deletion processor 384 subsequently performs a similar process on the pin ID “P0003”.

The pin ID “P0003” is a hierarchical pin. The deletion processor 384 thus executes a process A.

That is, the deletion processor 384 acquires a list of the pin IDs having the map ID “M0002” corresponding to the pin ID “P0003” as a value belonging to the map. In this example, the pin ID having the map ID “M0002” as the corresponding value is the pin ID “P0004”.

The deletion processor 384 performs on the pin ID “P0004” a process similar to that performed when the pin ID “0001” is selected as a pin ID subject to deletion. The deletion processor 384 has executed the process A on all the pin ID(s) having the value belonging to the map, the deletion processor 384 returns to the list of the pin IDs having the map ID “M0001” to perform the process on the next pin ID “P0005”. The pin ID “P0005” is not a hierarchical pin. Hence, the deletion processor 384 performs on the pin ID “P0005” a process similar to that performed when the pin ID “0001” is selected as a pin ID subject to deletion.

The deletion processor 384 subsequently stores in the trash box DB 370 the deletion group ID “2” issued after the pin ID “P0000” subject to deletion is received.

As described above, in this embodiment, when the selected pin ID subject to deletion is a hierarchical pin, all the inspection pins included within this layer are deleted at the same time. In addition, the attachment file corresponding to the selected pin ID subject to deletion is also deleted at the same time.

Note that FIG. 13 illustrates a case where the pin ID is selected as a pin ID subject to deletion; however, the inspection route as a whole may be subject to deletion instead of the pin ID. In this case, the deletion processor 384 may perform the process illustrated in FIG. 13 on all the pin IDs included in the selected inspection route subject to deletion.

Next, an illustration is given of a restoration process in the server 300 when the pin subject to restoration is selected in the terminal apparatus 200.

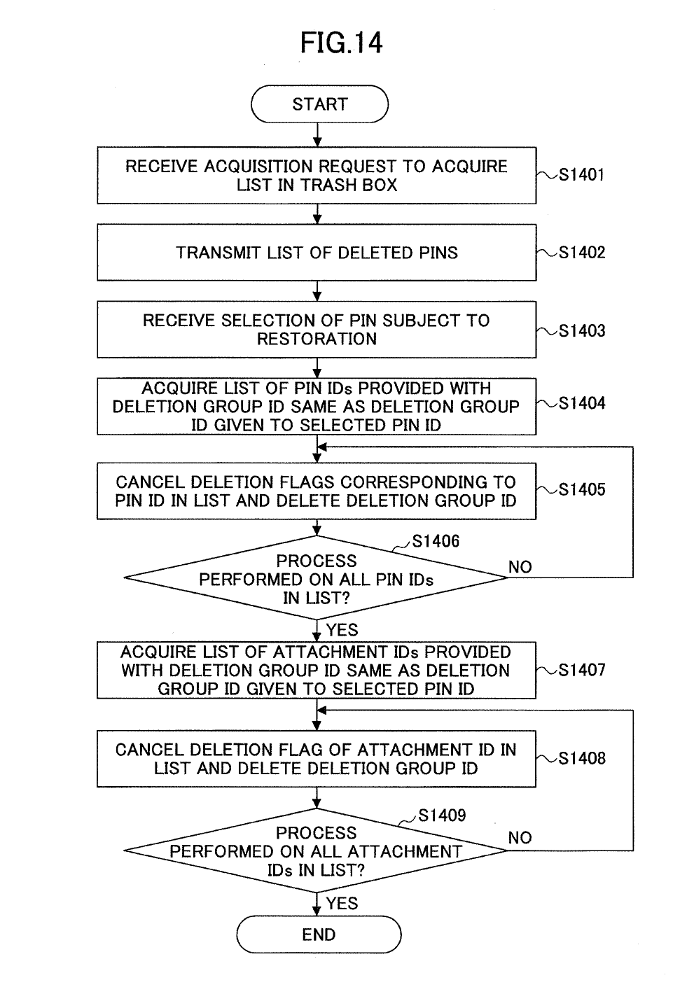

FIG. 14 is a flowchart illustrating the restoration process of the pin subject to restoration in the inspection information management system 100.

The server 300 receives an acquisition request to acquire a list of deleted files in a trash box from the terminal apparatus 200 (step S1401). The server 300 subsequently causes the restoration processor 385 to transmit a list of deleted pin IDs to the terminal apparatus 200 (step S1402). More specifically, the restoration processor 385 refers to the route record DB 340 to refer to the deleted pin IDs. The restoration processor 385 subsequently refers to the pin definition DB 310 based on the referred to pin IDs to acquire names corresponding to the pin IDs. The restoration processor 385 then transmits a list screen of the trash box including the acquired names to the terminal apparatus 200.

The restoration processor 385 subsequently receives the selected pin ID subject to restoration and the restoration request from the terminal apparatus 200 (step S1403). The restoration processor 385 subsequently acquires a list of the pin IDs provided with the deletion group ID the same as the deletion group ID given to the selected pin ID subject to restoration (step S1404).

The restoration processor 385 subsequently cancels the deletion flags corresponding to the pin ID included in the acquired list and deletes the deletion group ID (step S1405). More specifically, the restoration processor 385 changes the value of the deletion flag into a value that does not indicate deletion and deletes the deletion group ID (step S1405). The restoration processor 385 deletes a record of the corresponding pin ID from the trash box DB 370. The restoration processor 385 subsequently determines whether the deletion flags corresponding to all the pin IDs within the list have been cancelled and the corresponding deletion group IDs have been deleted (step S1406).

When the process of step S1406 has not been performed on all the pin IDs, the restoration processor 385 returns to step S1405.

When the process of step S1406 has been performed on all the pin IDs, the restoration processor 385 refers to the attachment DB 360 to acquire a list of the attachment IDs provided with the deletion group ID the same as the deletion group ID given to the pin ID subject to restoration (step S1407). The restoration processor 385 subsequently cancels the deletion flag corresponding to the attachment ID included in the acquired list and deletes the deletion group ID (step S1408). The restoration processor 385 subsequently determines whether the deletion flags corresponding to all the pin IDs within the list have been cancelled and the corresponding deletion group IDs have been deleted (step S1409).

When the process in step S1409 has not been performed on all the pin IDs, the restoration processor 385 returns to step S1408. When the process in step S1409 has been performed on all the pin IDs, the restoration processor 385 determines that restoration of the pin having the pin ID selected to be subject to restoration has completed to end the process.

According to above-described embodiment, when a pin is selected as a pin ID subject to restoration, the restoration processor 385 simultaneously restores the pins provided with the deletion group ID the same as the deletion group ID given to the pin ID of the selected pin. Accordingly, the pins deleted at the same time may be able to be restored at the same time to allow the deleted time to be consistent with the restored time.

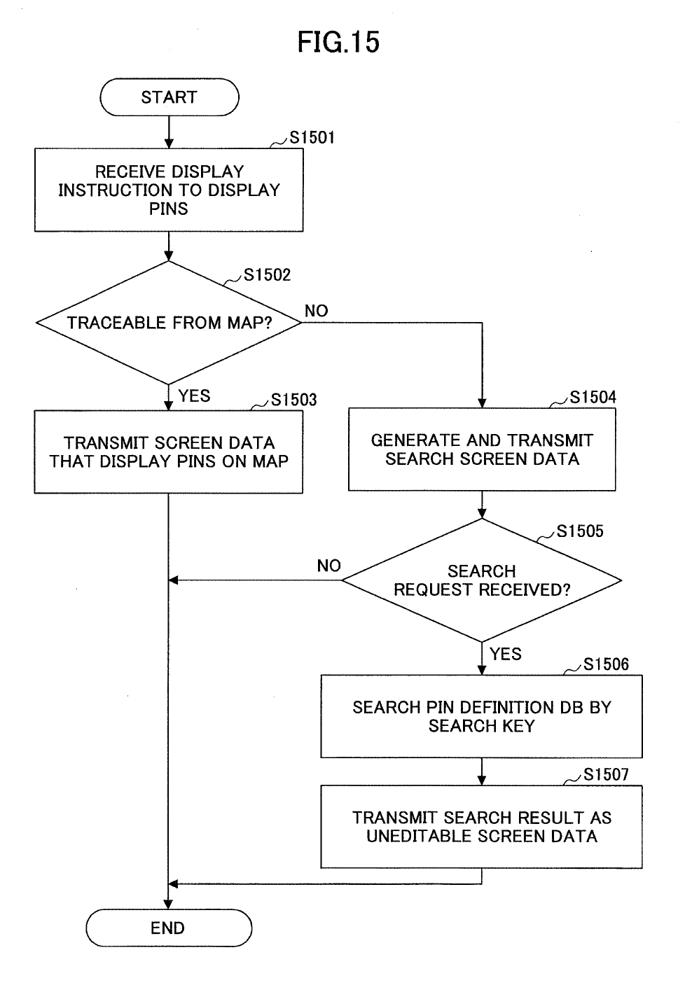

The following illustrates, with reference to FIG. 15, of a process of the server 300 when the server 300 has received from the terminal apparatus 200 the display request to display the restored pins. FIG. 15 is a flowchart illustrating a process of the server 300 that has received from the terminal apparatus 200 the display request to display the restored pins.

Note that in this embodiment, the process of restoring the deleted pins and a process of displaying the restored pins are described separately; however, the process of restoring the pins and the process of displaying the restored pins may be executed a sequence of processes. For example, when the server 300 receives the restoration request to restore the pins, the server 300 may additionally perform the process of displaying the pins illustrated in FIG. 15.

When the server 300 receives a display instruction to display the restored pins (step S1501), the screen data generator 386 refers to the pin definition DB 310 and the route definition DB 330 to determine whether the pins subject to display are traceable from the map ID (step S1502). More specifically, the screen data generator 386 determines whether there is any pin ID corresponding to which the deletion flag is set, among the hierarchical pins corresponding to all the layers of the maps from an uppermost layer map to the layer map to which the pin subject to display belongs.

When the pin subject to display is traceable from the map in step S1502, the screen data generator 386 generates screen data plotting the pin subject to display on the map to which the pin subject to display belongs, and transmits the generated screen data to the terminal apparatus 200 (step S1503). The terminal apparatus 200 causes the display controller 212 to display the pin subject to display on the map based on the screen data.

Note that a case where the pin is traceable from the map in this embodiment indicates that a correspondence relationship between the pin subject to display and the map or a correspondence relationship between the pin subject to display and the inspection route is restored as the correspondence relationship between the pin subject to display and the map or the correspondence relationship between the pin subject to display and the inspection route before the pin is deleted.

When the pin subject to display is not traceable from the map in step S1502, the screen data generator 386 generates screen data to receive the search request for pin information of the pin subject to display, and transmits the generated screen data to the terminal apparatus 200 (step S1504). Note that the screen data generator 386 may include a message indicating that the map to which the pin subject to display belongs has been deleted.

The screen data generator 386 subsequently determines whether the search request is received from the terminal apparatus 200 (step S1505). For example, in a case where the screen data generator 386 has not received the search request after a predetermined time being elapsed in step S1505, the screen data generator 386 ends the display process.

In a case where the screen data generator 386 has received the search request together with the search key in step S1505, the search part 387 searches the pin definition DB 310 by the search key (step S1506). The server 300 causes the screen data generator 386 to generate screen data to display the search result and transmit the generated screen data to the terminal apparatus 200 (step S1507). The screen data generator 386 generates the screen data to display the search result as uneditable screen data.

Note that in a case where the pin subject to display is not traceable from the map, a process of generating search screen data is illustrated as, but not limited to, an example in this embodiment. In a case where the pin subject to display is not traceable from the map, the server 300 may report that the pin is unable to be displayed to the terminal apparatus 200 to end the display process. In this case, when the server 300 receives the search request from the terminal apparatus 200 again, the server 300 may start the process illustrated in step S1504.

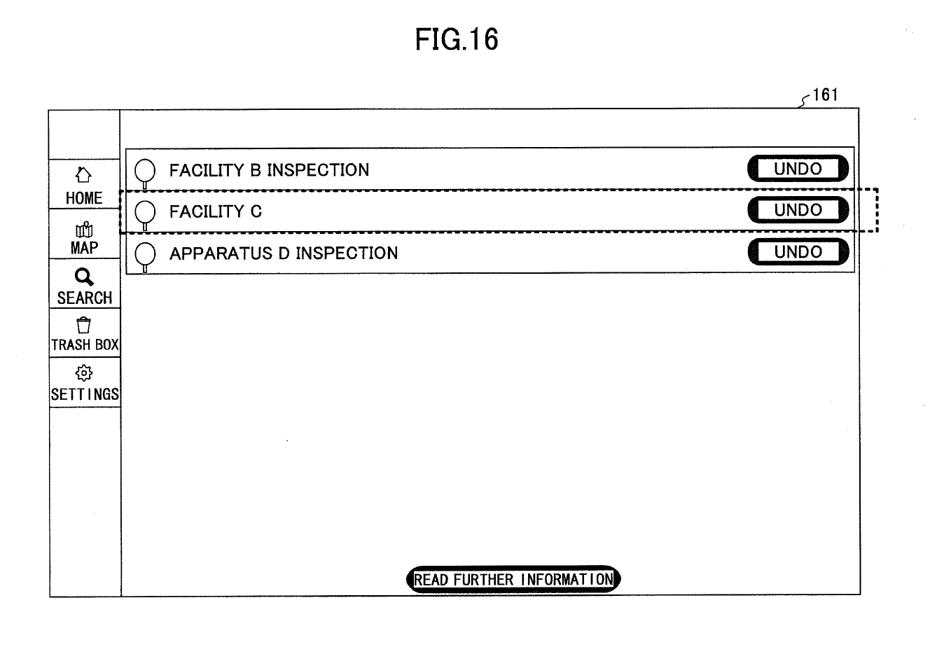

The following illustrates display of restored pin in the inspection information management system 100 with reference to FIGS. 16 to 19.

FIG. 16 is a diagram illustrating an example of a trash box list screen displayed on the terminal apparatus 200. The list screen illustrated in FIG. 16 displays, as the deleted pins, a pin (a pin name “facility B inspection”) of a pin ID “P0002”, a pin (a pin name “facility C”) of a pin ID “P0003”, and a pin (a pin name “apparatus D inspection”) of a pin ID “P0004”.

Initially, a description is given of a case in FIG. 16 where the pin ID “P0002” (the pin name “facility B inspection”) is selected to be subject to restoration, and the pin ID “P0002” is then selected to be subject to display.

When the pin ID “P0002” is selected to be subject to restoration, the server 300 causes the restoration processor 385 to cancel the deletion flag from the pin ID “P0002” in the pin definition DB 310, and delete the deletion group ID corresponding to the pin ID “P0002”.

The screen data generator 386 subsequently refers to the pin definition DB 310 and the route definition DB 330 to determine whether the map to which the pin ID “P0002” belongs is traceable in the order from an uppermost layer map to the layer map to which the pin ID “P0002” belongs.

The map to which the pin ID “P0002” belongs is the map having the map ID “M0001”. The example of FIG. 16 does not include a pin ID “P0000” of a hierarchical pin corresponding to the map ID “M0001”, and the pin ID “P0000” is not subject to deletion.

Thus, the screen data generator 386 generates screen data plotting the map having the map ID “M0001” illustrating the pin ID “P0002”, and transmits the generated screen data to the terminal apparatus 200.

The terminal apparatus 200 receives the screen data, and displays the map having the map ID “M0001” in which the pin ID “P0002” is restored.

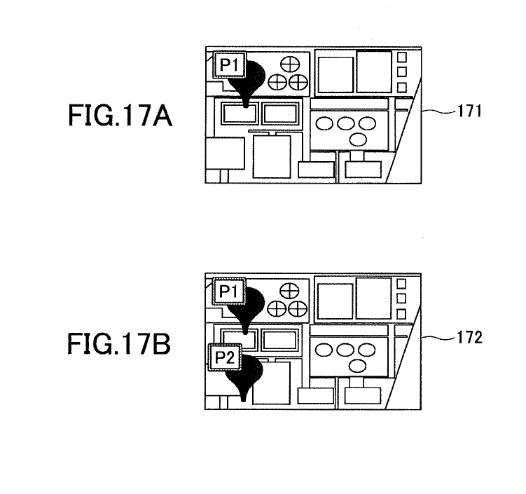

FIGS. 17A and 17B are diagrams illustrating the map before the pin ID “P0002” is restored and the map after the pin ID “P0002” is restored. FIG. 17A illustrates an example of the screen displaying on the terminal apparatus 200 a map having the map ID “M0001” before the pin ID “P0002” is restored. FIG. 17B illustrates an example of the screen displaying on the terminal apparatus 200 a map having the map ID “M0001” after the pin ID “P0002” is restored.

The map 171 illustrated in FIG. 17A displays a state in which the pin ID “P0002” and the pin ID “P0003” are deleted from the map 171.

The map 172 illustrated in FIG. 17B displays the pin ID “P0002” because the map ID “M0001” to which the pin having the pin ID “P0002” belongs is not subject to deletion.

In this embodiment, when the pin ID “P0002” of the map 172 is selected in the terminal apparatus 200, an input screen having an entry field of the item corresponding to the pin ID “P0002” is displayed.

When an attachment file attached to the pin ID “P0002” is present together with the pin ID “P0002”, and the pin ID “P0002” is selected on the map 172, information indicating the presence of the attachment file may be displayed.

Next, a description is given of a case in FIG. 16 where the pin ID “P0004” (the pin name “facility D inspection”) is selected to be subject to restoration, and the pin ID “P0004” is then selected to be subject to display.

When the pin ID “P0004” is selected to be subject to restoration, the server 300 causes the restoration processor 385 to cancel the deletion flag from the pin ID “P0004” in the pin definition DB 310, and delete the deletion group ID corresponding to the pin ID “P0004”.

The screen data generator 386 subsequently refers to the pin definition DB 310 and the route definition DB 330 to determine whether the map to which the pin ID “P0004” belongs is traceable in the order from an uppermost layer map to the layer map to which the pin ID “P0004” belongs.

In the example of FIG. 16, the map having the map ID “M0001” is not subject to deletion. The map having the map ID “M0001” is the uppermost layer map of the map to which the pin ID “P0004” belongs. However, in the example of FIG. 16, the pin having the pin ID “P0003” is subject to deletion. The pin ID “P0003” is a hierarchical pin indicating the map ID “M0002” to which the pin ID “P0004” belongs. Thus, the pin ID “P0004” is not traceable from the uppermost map to the map to which the pin ID “P0004” belongs.

The screen data generator 386 thus generates search screen data via which the search key associated with the pin subject to display is input, and transmits the generated search screen data to the terminal apparatus 200. When the search key is input in the terminal apparatus 200 and the server 300 receives the search request, the server 300 causes the search part 387 to search the pin record DB 320 by the search key. The server 300 causes the screen data generator 386 to generate screen data to display the search result and transmit the generated screen data to the terminal apparatus 200.

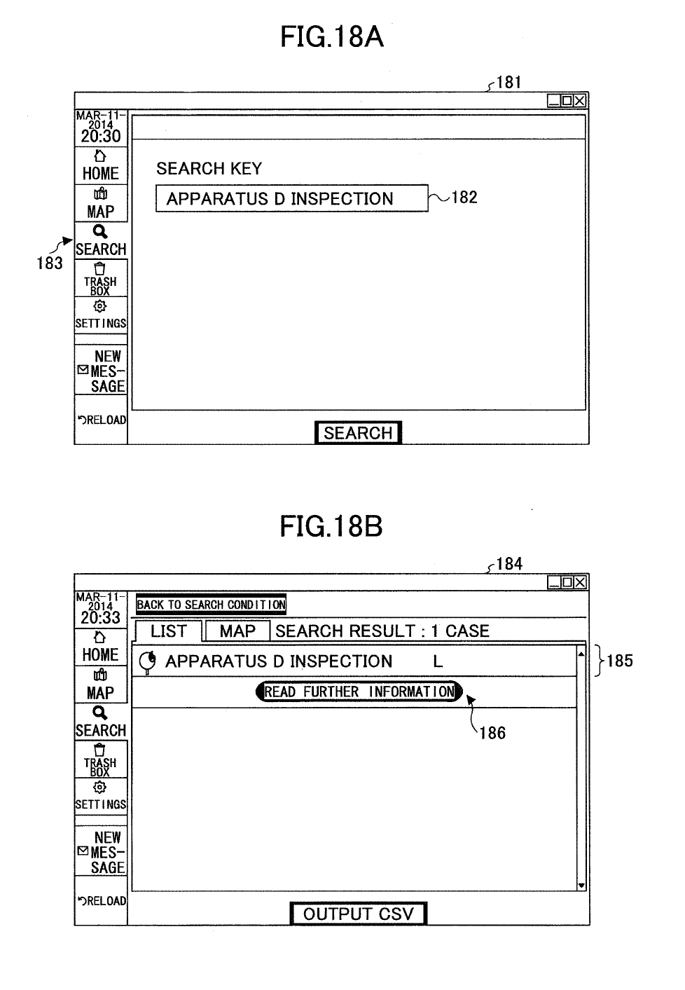

FIGS. 18A and 18B are examples of screens via which a pin subject to display is searched for. FIG. 18A illustrated an example of a search screen to which the search key is input, and FIG. 18B illustrates an example of a search result screen displaying the search result.

The search screen 181 illustrated in FIG. 18A includes an entry field 182 for the search key and a search button 183. When the search key is input into the entry field 182 and the search button 183 is pressed, the terminal apparatus 200 transmits the search key and search request to the server 300.

The search result screen 184 illustrated in FIG. 18B may display a pin name 185 extracted as the search result. When a button 186 for acquiring pin record information corresponding to the pin ID is pressed on the search result screen 184, the terminal apparatus 200 transmits an acquisition request for the pin record information corresponding to the pin ID to the server 300.

When the server 300 receives the acquisition request for the pin record information, the server 300 causes the screen data generator 386 to generate screen data to display pin record information and transmit the generated screen data to the terminal apparatus 200.

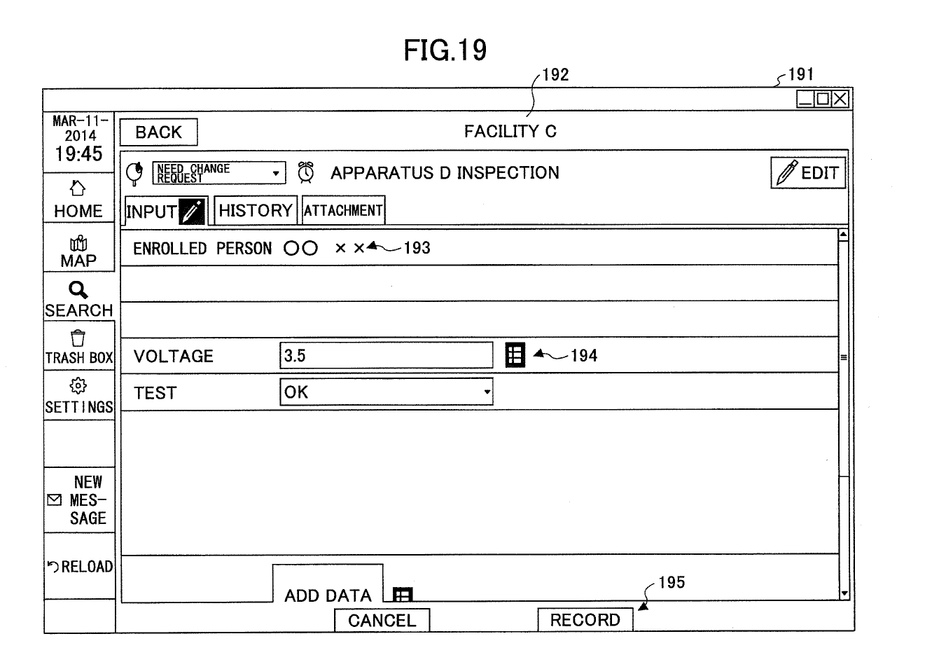

FIG. 19 is a diagram illustrating an example of a screen displaying the pin record information. FIG. 19 depicts a screen 191 displaying a display field 192 to display a map name of the map to which the pin ID “P0004” belongs, and a display field 193 to display a registered member of the pin record information, and a display field 194 to display an input item corresponding to the pin ID and a value of the item.

The screen 191 displays a record button 195; however, the record button 195 is displayed to be inactive.

That is, the screen 191 of the terminal apparatus 200 displays the pin record information that will not accept editing or input.

As illustrated above, when the restored pin ID is displayed and this pin ID is traceable from the map, the restored pin ID displayed may accept reentry or editing of the inspection result of the restored pin. However, when the restored pin ID is not traceable from the map, the restored pin ID displayed will not accept reentry or editing of the inspection result of the restored pin.

According to the above-described embodiment, when the inspected pin is deleted by an erroneous operation during inspection along the inspection route, the deleted pin may be immediately restored to continue the inspection. In this case, it is possible to immediately continue to reenter or edit the inspection result of the deleted pin.

Moreover, when the map or the inspection route is already deleted, but the user desires to refer to the pin record information, it is possible to display the pin record information alone as the search result. Thus, according to the embodiment described above, it is possible to prevent the previous pins currently excluded from the inspection route from being displayed. Accordingly, the inspection worker may be prevented from erroneously recognizing the previous pins as the currently effective pins subject to entry.

### Second Embodiment

The following illustrates a second embodiment of an inspection information management system 100. In the second embodiment, an attachment file is deleted and restored in the terminal apparatus 200.

Initially, an illustration is given of a deletion process in the server 300 when the attachment file subject to deletion is selected in the terminal apparatus 200.

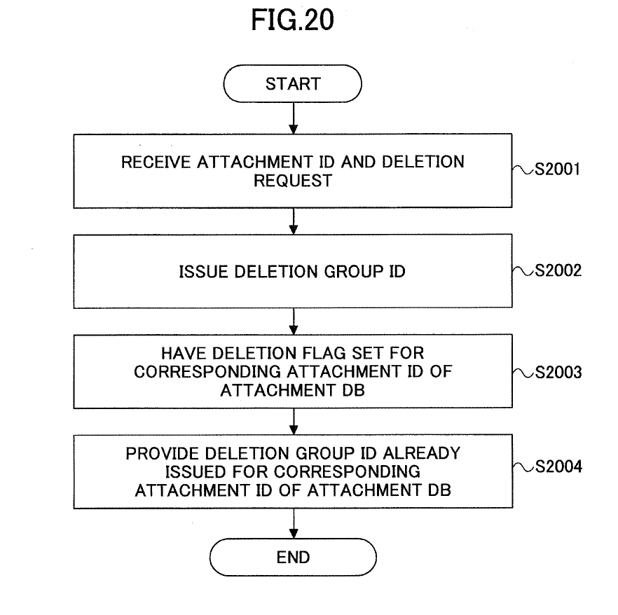

FIG. 20 is a flowchart illustrating a deletion process of an attachment file in the inspection information management system 100.

In this embodiment, the server 300 causes the input receiver 381 to receive the attachment ID of the selected attachment file subject to deletion selected in the terminal apparatus 200 and the deletion request (step S2001). The server 300 subsequently causes the deletion processor 384 to issue the deletion group ID (step S2002).

The deletion processor 384 subsequently sets the deletion flag corresponding to the attachment ID received in step S2001 in the attachment DB 360 (step S2003), and provides the attachment ID with the issued deletion group ID (step S2004). That is, in this embodiment, the selected pin ID subject to deletion and the attachment ID corresponding to this pin ID are identical.

The deletion processor 384 subsequently stores the issued deletion group ID into the trash box DB 370 to end the pin deletion process.

In this embodiment, for example, when the attachment ID “T01” attached to the pin ID “P0001” is subject to deletion in the terminal apparatus 200, the server 300 receives the attachment ID “T01”. The server 300 subsequently sets the deletion flag corresponding to the attachment ID “T01”, and provides the attachment ID “T01” with the deletion group ID in the attachment DB 360. FIG. 8 illustrates an example of the attachment ID “T01” being provided with the deletion group ID “1”.

Next, an illustration is given of a restoration process in the server 300 when the attachment file subject to restoration is selected in the terminal apparatus 200.

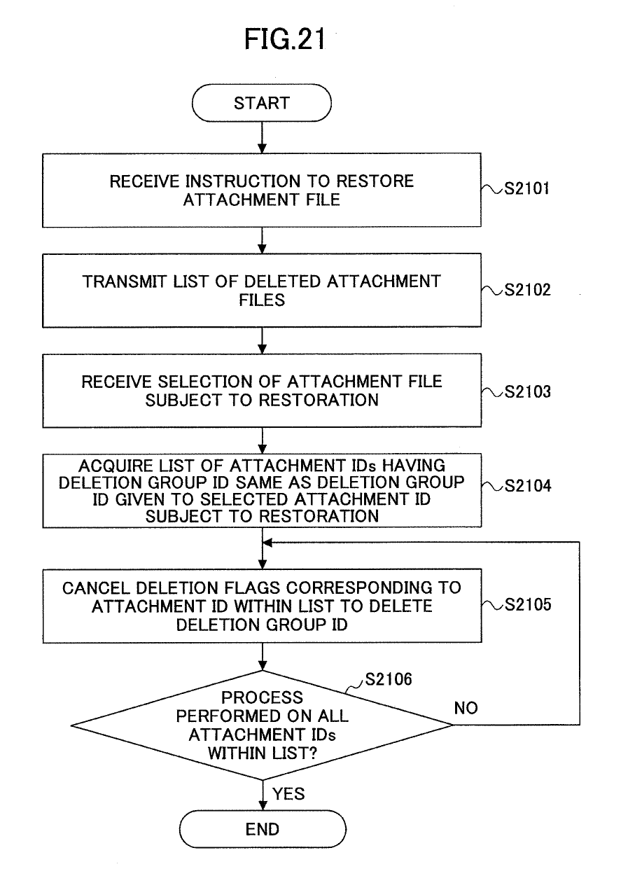

FIG. 21 is a flowchart illustrating a restoration process of an attachment file in the inspection information management system 100.

The server 300 receives an acquisition request to acquire a list of deleted files in a trash box from the terminal apparatus 200 (step S2101). The server 300 subsequently causes the restoration processor 385 to transmit a list of deleted attachment files to the terminal apparatus 200 (step S2102). More specifically, the restoration processor 385 refers to the trash box DB 370 to refer to the deleted attachment IDs. The restoration processor 385 subsequently refers to the attachment DB 360 based on the referred to attachment IDs to acquire names corresponding to the attachment IDs. The restoration processor 385 then transmits a list screen of the trash box including the acquired names to the terminal apparatus 200.

The restoration processor 385 subsequently receives the selected attachment ID subject to restoration and the restoration request from the terminal apparatus 200 (step S2103). The restoration processor 385 subsequently acquires a list of the attachment IDs provided with the deletion group ID the same as the deletion group ID given to the selected attachment ID subject to restoration (step S2104).

The restoration processor 385 subsequently cancels the deletion flag corresponding to the attachment ID included in the acquired list. More specifically, the restoration processor 385 changes the value of the deletion flag into a value that does not indicate deletion to delete the deletion group ID (step S2105). The restoration processor 385 deletes a record of the corresponding attachment ID from the trash box DB 370. The restoration processor 385 subsequently determines whether the deletion flags corresponding to all the pin IDs have been cancelled and the corresponding deletion group ID have been performed within the list (step S2106).

When the process in step S2106 has not been performed on all the attachment IDs, the restoration processor 385 returns to step S2105.

When the process in step S2106 has been performed on all the attachment IDs, the restoration processor 385 ends the process.

According to above-described embodiments, when an attachment file subject to restoration is selected, the restoration processor 385 simultaneously restores the attachment file provided with the deletion group ID the same as the deletion group ID provided with the attachment ID of the selected attachment file. Accordingly, the attachment files deleted at the same time may be able to be restored at the same time to allow the deleted time to be consistent with the restored time.

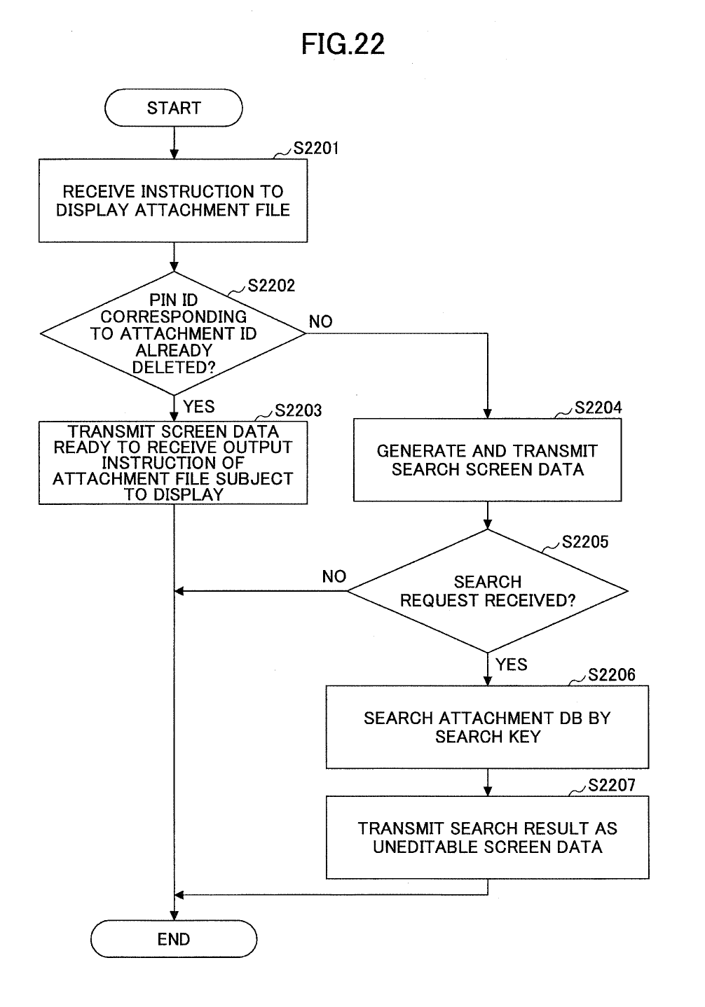

The following illustrates, with reference to FIG. 22, of a process of the server 300 when the server 300 has received from the terminal apparatus 200 the display request to display the restored attachment files. FIG. 22 is a flowchart illustrating a process of the server 300 that has received from the terminal apparatus 200 the display request to display the restored attachment files.

Note that in this embodiment, the process of restoring the deleted attachment files and a process of displaying the restored attachment files are described separately; however, the process of restoring the attachment files and the process of displaying the attachment files may be executed a sequence of processes. For example, when the server 300 receives the restoration request to restore the attachment files, the server 300 may perform the process of displaying the attachment files illustrated in FIG. 22.

When the server 300 receives the display instruction to display the restored attachment files (step S2201), the server 300 causes the screen data generator 386 to refer to the pin definition DB 310 to determine whether the pins corresponding to the attachment files subject to display have been deleted (step S2202). More specifically, the screen data generator 386 determines whether the deletion flags are set to the pin IDs corresponding to the received attachment IDs subject to display.

When the deletion flags are not set to the corresponding deletion pin IDs, the screen data generator 386 generates screen data ready to receive an instruction to output the attachment files subject to display, and transmits the generated screen data to the terminal apparatus 200 (step S2203).

When the deletion flags are set corresponding attachment IDs in step S2202, the screen data generator 386 generates screen data to receive the search request for attachment files subject to display and transmits the generated screen data to the terminal apparatus 200 (step S2204). Note that the screen data generator 386 may include a message indicating that the pins to which the attachment files subject to display are attached have been deleted.

The screen data generator 386 subsequently determines whether the search request is received from the terminal apparatus 200 (step S2205). For example, when the screen data generator 386 has not received the search request after a predetermined time being elapsed, the screen data generator 386 ends the display process.

In a case where the screen data generator 386 has received the search request together with the search key in step S2205, the search part 387 searches the attachment DB 360 by the search key (step S2206). The server 300 causes the screen data generator 386 to generate screen data to display the search result and transmit the generated screen data to the terminal apparatus 200 (step S2207). The screen data generator 386 generates the screen data to display the search result as screen data incapable of receiving an instruction to edit the attachment files.

Note that in a case where the pins corresponding to the attachment files subject to display are deleted, a process of generating search screen data is illustrated as, but not limited to, an example of a sequence of processes in this embodiment. For example, when the pins corresponding to the attachment files are deleted, the server 300 may report to the terminal apparatus 200 that the content of the attachment files are not displayed to end the display process. In this case, when the server 300 receives the search request from the terminal apparatus 200 again, the server 300 may start the process illustrated in step S2204.

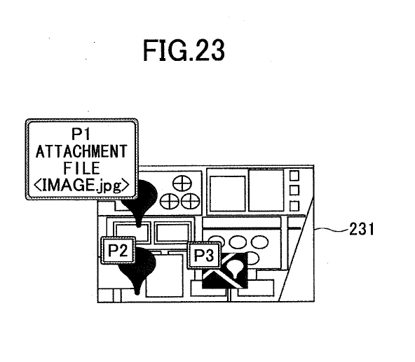

FIG. 23 is a diagram illustrating an example of a state where the attachment ID “T01” is restored. FIG. 23 depicts a state where the attachment file is restored when the pin corresponding to the attachment ID “T01” subject to display is not deleted.

The attachment ID “T01” corresponds to the pin ID “P0001”, and the attachment file of the attachment ID “T01” is attached to the pin of the pin ID “P0001”.

When the pin having the pin ID “P0001” is selected on a screen 231, the screen 231 displays a balloon 232 indicating the presence of the attachment file having the attachment ID “T01”.

The file name of the attachment file may be displayed within the balloon 232. In addition, when the attachment file is selected within the balloon 232, the terminal apparatus 200 may transmit the acquisition request for the attachment file to the server 300. When the server 300 receives the acquisition request for the attachment ID and the attachment file, the server 300 transmits the corresponding attachment file to the terminal apparatus 200. The terminal apparatus 200 displays the acquired attachment file to be editable.

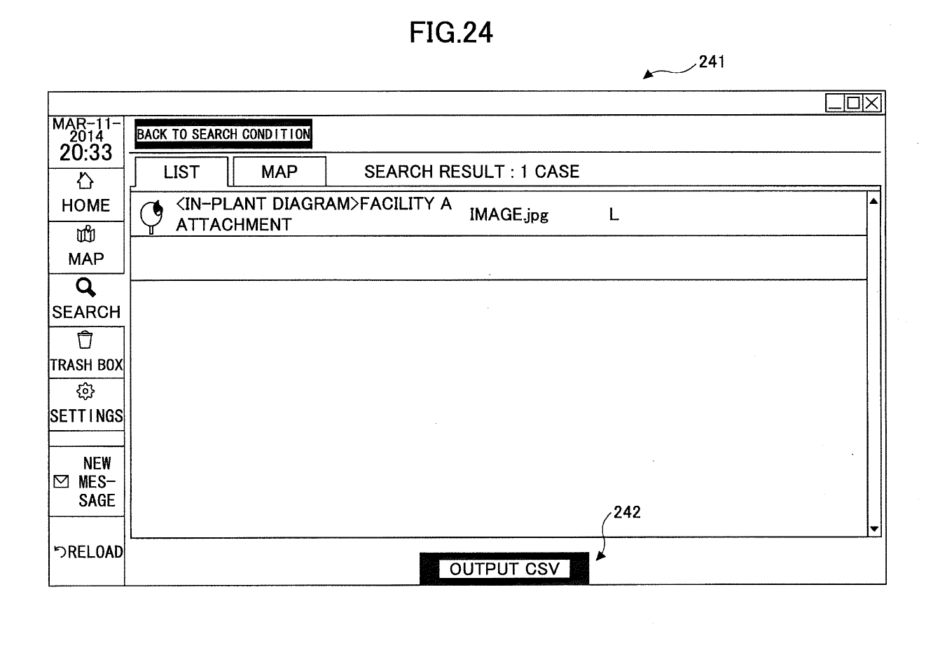

FIG. 24 is a diagram illustrating an example of a search result of the attachment ID “T01”. FIG. 24 depicts a state where the attachment file is found when the pin corresponding to the attachment ID “T01” subject to display is deleted.

Note that the search key for searching for the attachment file is input in the entry field 182 of a search screen 181 illustrated in FIG. 18A. The server 300 receives the search key and the search request, and performs the search.

FIG. 24 depicts a search result screen 241 displaying the attachment file having the file name “image.jpg” corresponding to the attachment ID “T01” as the search result.

The search result screen 241 also displays a button 242 to execute an instruction to output the attachment file displayed as the search result. Note that the search result screen 241 in this example does not display a button for re-registering the attachment file that has already been output with respect to the pin. The search result screen 241 thus prevents the attachment file from being registered corresponding to the pin again after the attachment file displayed as the search result has been updated.

The user may be allowed to operate to create a new document and register the created document corresponding to a not-deleted different pin as the attachment file using the referred to attachment file. On the other hand, the user is not allowed to register the edited attachment file that has been referred to corresponding to the same pin; that is, the user is not allowed to register edited attachment file corresponding to the deleted pin. That is, the operation to update the attachment file registered corresponding to the deleted pin is prevented.

In the above-described embodiment, editability of the attachment file subject to restoration may be controlled. For example, when the attachment file is deleted by an erroneous operation during inspection conducted along the inspection route, the deleted attachment file may immediately be restored and content of the restored attachment file may be checked. In this case, the restored attachment file may continuously be edited.

Further, an attachment result of the attachment file may only be displayed for referring to the attachment file when the pin provided with the attachment file subject to restoration is deleted. Thus, it may be possible to prevent the attachment file corresponding to a non-existing pin from being edited.

The disclosed embodiments may control editability of restored information.

According to an aspect of the embodiments, there is provided an inspection information management method executed by a computer. The inspection information management method includes receiving selection of a first pointer as a pointer subject to restoration after the first pointer has been selected as a pointer subject to deletion, the first pointer being one of a pointer indicating an inspection location displayed on a map indicating an arrangement of facilities and a pointer indicating an inspection location included in an inspection route indicating an order of a plurality of inspection locations subject to inspection, the first pointer being stored in association with accompanying information; and restoring the first pointer and the accompanying information such that the accompanying information is in an editable state in a case where one of the map and the inspection route in association with the first pointer is not subject to deletion; or restoring the first pointer and the accompanying information such that the accompanying information is in an uneditable state in a case where one of the map and the inspection route in association with the first pointer is subject to deletion.

The above-described process may be implemented by functional components of a computer, steps executed by the computer, or a recording medium storing a program executing the process.

The present invention is not limited to the examples or embodiments specifically disclosed above. Various modifications or alteration may be made without departing from the scope of the claims of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

1. An inspection information management method executed by a computer, the inspection information management method comprising:
receiving selection of a first pointer as a pointer subject to restoration after the first pointer has been selected as a pointer subject to deletion, the first pointer being one of a pointer indicating an inspection location displayed on a map indicating an arrangement of facilities and a pointer indicating an inspection location included in an inspection route indicating an order of a plurality of inspection locations subject to inspection, the first pointer being stored in association with accompanying information; and
restoring the first pointer and the accompanying information such that the accompanying information is in an editable state in a case where one of the map and the inspection route in association with the first pointer is not subject to deletion; or
restoring the first pointer and the accompanying information such that the accompanying information is in an uneditable state in a case where one of the map and the inspection route in association with the first pointer is subject to deletion.

2. The inspection information management method as claimed in claim 1, wherein
when the map or the inspection route is present, a restoration destination of the first pointer subject to restoration in the restoring is determined by displaying the first pointer in a state capable of receiving an output instruction on a screen displaying the map or a screen displaying the inspection route, and
when the map or the inspection route is not present, the restoration destination of the first pointer subject to restoration in the restoring is determined by displaying the first pointer on a search result screen alone corresponding to the first pointer without displaying the first pointer on any of the screen displaying the map and the screen displaying the inspection route.

3. The inspection information management method as claimed in claim 2, wherein
when the search result screen receives an output instruction to output the accompanying information of the first pointer, the search result screen displays the accompanying information in an uneditable state.

4. An inspection information management method executed by a computer, the inspection information management method comprising:
receiving selection of a file including one of a document and an image as a file subject to restoration after the file has been selected as a file subject to deletion, the file being stored in association with one of a pointer indicating an inspection location displayed on a map indicating an arrangement of facilities and a pointer indicating an inspection location included in an inspection route indicating an order of a plurality of inspection locations subject to inspection;
restoring the file corresponding to the pointer such that the file is in an editable state in a case where the pointer corresponding to the file is not subject to deletion; or
restoring the file corresponding to the pointer such that the file is in an uneditable state in a case where the pointer corresponding to the file is subject to deletion.

5. The inspection information management method as claimed in claim 4, wherein
when the pointer is present, a restoration destination of the file subject to restoration in the restoring is determined by displaying the file in a state capable of receiving an output instruction to output the file on a screen displaying the pointer, and when the pointer is not present, the restoration destination of the file subject to restoration in the restoring is determined by displaying the file on a search result screen alone without displaying the screen displaying the pointer.

6. The inspection information management method as claimed in claim 5, wherein
the search result screen is displayed in a state incapable of receiving the output instruction to output the file.

7. A non-transitory computer-readable storage medium having stored therein an inspection information management program for causing a computer to execute a process, the process comprising:
receiving selection of a first pointer as a pointer subject to restoration after the first pointer has been selected as a pointer subject to deletion, the first pointer being one of a pointer indicating an inspection location displayed on a map indicating an arrangement of facilities and a pointer indicating an inspection location included in an inspection route indicating an order of a plurality of inspection locations subject to inspection, the first pointer being stored in association with accompanying information; and
restoring the first pointer and the accompanying information such that the accompanying information is in an editable state in a case where one of the map and the inspection route in association with the first pointer is not subject to deletion; or
restoring the first pointer and the accompanying information such that the accompanying information is in an uneditable state in a case where one of the map and the inspection route in association with the first pointer is subject to deletion.

8. A non-transitory computer-readable storage medium having stored therein an inspection information management program for causing a computer to execute a process, the process comprising:
receiving selection of a file including one of a document and an image as a file subject to restoration after the file has been selected as a file subject to deletion, the file being stored in association with one of a pointer indicating an inspection location displayed on a map indicating an arrangement of facilities and a pointer indicating an inspection location included in an inspection route indicating an order of a plurality of inspection locations subject to inspection;
restoring the file corresponding to the pointer such that the file is in an editable state in a case where the pointer corresponding to the file is not subject to deletion; or
restoring the file corresponding to the pointer such that the file is in an uneditable state in a case where the pointer corresponding to the file is subject to deletion.

9. An inspection information management system comprising:
a terminal apparatus for use in facility inspection; and
a server configured to manage information in association with inspection input from the terminal apparatus,
the terminal apparatus having a memory and one or more processors configured to perform a process, the process including
receiving selection of a first pointer as a pointer subject to restoration after the first pointer is selected as a pointer subject to deletion, the first pointer being one of a pointer indicating an inspection location displayed on a map indicating an arrangement of facilities and a pointer indicating an inspection location included in an inspection route indicating an order of a plurality of inspection locations subject to inspection, the first pointer being stored in association with accompanying information,
the server having a memory and one or more processors configured to perform a process, the process including
restoring the first pointer and the accompanying information such that the accompanying information is in an editable state in a case where one of the map and the inspection route in association with the first pointer is not subject to deletion, and to restore the first pointer and the accompanying information such that the accompanying information is in an uneditable state in a case where one of the map and the inspection route in association with the first pointer is subject to deletion.

10. An inspection information management system comprising:
a terminal apparatus for use in facility inspection; and
a server configured to manage information in association with inspection input from the terminal apparatus,
the terminal apparatus having a memory and one or more processors configured to perform a process, the process including
receiving selection of a file including one of a document and an image as a file subject to restoration after the file has been selected as a file subject to deletion, the file being stored in association with one of a pointer indicating an inspection location displayed on a map indicating an arrangement of facilities and a pointer indicating an inspection location included in an inspection route indicating an order of a plurality of inspection locations subject to inspection,
the server having a memory and one or more processors configured to perform a process, the process including
restoring the file corresponding to the pointer such that the file is in an editable state in a case where the pointer corresponding to the file is not subject to deletion, and to restore the file corresponding to the pointer such that the file is in an uneditable state in a case where the pointer corresponding to the file is subject to deletion.
